(19) United States
(12) Patent Application Publication
(10) Pub. No.: US 2008/0191530 A1
(43) Pub. Date: Aug. 14, 2008

(54) Special expandable booster bench

(76) Inventor: Christina L. Basham, Elwood, IN (US)

Correspondence Address: RITCHISON LAW OFFICES, PC, 115 EAST NINTH STREET - SUITE A, ANDERSON, IN, 46016-1507, US

(21) Appl. No.: 12/082,148

(22) Filed: Apr. 9, 2008

Related U.S. Application Data
(63) Continuation-in-part of application No. 11/447,835, filed on Jul. 21, 2006.

(51) Int. Cl. B60N 2/28

(52) U.S. Cl. 297/236

(57) ABSTRACT

A booster seat device called a Special Expandable Booster Bench. This device is a booster seat system where a combination of benches nest inside of one another until needed. The device is comprised of two or more benches and a means to slide or interconnect the benches to each other and to the vehicle seat. The purpose of this bench system is to allow a person to store the extra seats when not being used. Mothers and persons responsible for two or more children, are often legally required to keep the children in a booster seats. These persons well appreciate that when extended there will be one (1) long bench across the back seat of a vehicle for all multiple children. When not needed the bench compact into one nest providing full use of the remaining areas.

### BACKGROUND—FIELD OF INVENTION AND PRIOR ART

The new Special Expandable Booster Bench and the like described in this specification is a support bench system that is designed to carry several children as the expanded device and then be nested during periods when the multiple benches are not needed.

A. Introduction of the Problems Addressed

Traditionally, the Booster Bench devices to date are singular devices that are not usable for multiple children and are difficult to store and re-install for use in the vehicle. In addition, multiple devices are linearly priced and therefore more expensive than the present invention. Some are bulky and complex to use. Further, much time and space is wasted by the user.

B. Prior Art

The historical technology focused mainly on singular booster seats. Devices have attempted to address individual booster seats with limited success for multiple systems. However, for the problems as stated the prior art devices were often complex, difficult to install and limited in use. The advantages and objectives of the new Special Expandable Booster Bench are well stated below in detail. This new device addresses these limitations and provides a solution to the stated problems. In the area of vehicle seating, early devices were developed for full sized people but not for infants and smaller children.

Examples of prior anchor devices begin with U.S. Pat. No. 151,411 issued to Marshall (1874). This invention teaches a door step seat for hoses and stoops. Nothing is taught for safety or a booster bench. Next, is U.S. Pat. No. 354,860 issued to Guiet (1886) which teaches a single pull out seat for two wheeled carts and the like. No boost or “raising” of an adult or child is taught or anticipated.

A further example of a seat system is shown by Swanson in U.S. Pat. No. 600,812 (1898). This teaches a piano stool that swings out to provide two additional stools, arguably for playing duets on the piano. No support or elevation of the occupiers is taught. A Pull-out vehicle seat is taught by Moore in U.S. Pat. No. 972,393 (1910). This teaches a pull-out portion that is incorporated as part of the vehicle seat and provides no mention of a separate booster feature. It also lacks multiple benches.

In the U.S. Pat. No. 2,696,246 (1954), Putnam taught an expansion extension to a vehicle seat which straddled the open area between a back seat bench and the front seat “back”. The device did not show boosting a child or any safety features to restrain/contain the infant safely. Another U.S. Pat. No. 2,699,202 (1955) by Leary, et al shows an expansible chair for use as a piece of furniture. The device is independent of any vehicle device and does not teach a booster feature.

Another U.S. Pat. No. 4,099,770 (1978) by Elsholz, et al shows a singular booster bench without any multiple or expanded features as provided by the unique Special Expandable Booster Bench. A very complex booster bench device is taught by Czernakowski in the U.S. Pat. No. 5,409,294 (1995). The mechanism is very complex booster seat with only a unitary bench provided. The cost to produce the taught device appears excessive in comparison to the new device taught herein.

The parent patent application Ser. No. 11/447,835, filed Jul. 21, 2006 by Christina L. Basham and entitled “Booster Bench” demonstrates and teaches another booster seat device with a more complex expansion means including slotted tracks and multiple engagement means. This Continuation in Part has new matter with more simple means to expand the benches and then re-nest to one position.

As far as known, there are no booster seat devices at the present time which fully meet this need with as few components and superior operation as the present Special Expandable Booster Bench device. It is believed that this expandable bench device is made with fewer parts, of a more durable design, and with much improved features and capabilities than any previous booster bench devices.

### SUMMARY OF THE INVENTION

A Special Expandable Booster Bench has been developed for use by a person to mount and secure in a vehicle for use with multiple infants during transport. The device includes multiple seats that originally nest into one assembly, then the nested benches may be expanded to multiple benches with security features. The device includes multiple seats that may nest within each other. The device has a means to interlock with each other bench as well as means to lock the device to the vehicle seat. The preferred embodiment of the device is therefore comprised of a plurality of benches, a means to interlock or nest the benches, a means to connect to the vehicle seat, and other features for safety and convenience.

The preferred embodiment of the device is comprised of several structural members, namely a plurality of bench seats, features to secure to the other bench seats together, and features to secure to the vehicle bench seats.

The newly invented Special Expandable Booster Bench device features mostly common, readily available parts. In operation, the new Special Expandable Booster Bench device may be assembled and operated with common fasteners and tools.

### OBJECTS AND ADVANTAGES

There are several objects and advantages of the Special Expandable Booster Bench device. There currently exist few mechanisms that permit a secure connection for infant seats that also permits multiple benches for infants.

One advantage and object of the present invention is that is simple to use. This means the Special Expandable Booster Bench can be used by a person to securely control and secure infants of one or more in the vehicle.

Another advantage and object for the Special Expandable Booster Bench device is to provide a device that is compact. When fewer than three children/infants are present, the easy to store features make the device effective for persons that use their vehicle for infant transport and other uses. When not needed the device may be compacted to one seat, leaving space in the vehicle for other uses.

Another object of the present invention to be economical. The multi seat or bench features reduce the total costs and provide significant improvements in providing multiple or Special Expandable Booster Bench.

A further advantage for the Special Expandable Booster Bench is that it is easy to install. Safety belts and decisions for one, two, or three benches are the main, decisive points, a two wedge system functions well. Additional members may be stacked to achieve more interference and engagement and thereby provide added retention forces.

Other additional safety features are configured into the Special Expandable Booster Bench. The bench system is also durable and strong. Finally, other advantages and additional features of the present Special Expandable Booster Bench device will be more apparent from the accompanying drawings and from the full description of the device. For one skilled in the art of bench devices and such, it is readily understood that the features shown in the examples with this mechanism are readily adapted to other types of booster bench devices and systems.

### DESCRIPTION OF THE DRAWINGS—FIGURES

The accompanying drawings, which are incorporated in and constitute a part of this specification, illustrate an embodiment of the Special Expandable Booster Bench device that is preferred. The drawings together with the summary description given above and a detailed description given below serve to explain the principles of the Special Expandable Booster Bench device. It is understood, however, that the Special Expandable Booster Bench device is not limited to only the precise arrangements and instrumentalities shown.

FIGS. 1 A through 1 C are sketches of a preferred embodiment of a SPECIAL EXPANDABLE BOOSTER BENCHES system. FIG. 1 A is the Lowermost or bottom BOOSTER BENCH. FIG. 1 B is the Nested three SPECIAL EXPANDABLE BOOSTER BENCHES. FIG. 1 C Expanded SPECIAL EXPANDABLE BOOSTER BENCHES.

FIG. 2 A through 2 D are sketches Expanded SPECIAL EXPANDABLE BOOSTER BENCH with the various components noted.

FIG. 3 A through 3 C are sketches showing the method of using the SPECIAL EXPANDABLE BOOSTER BENCHES.

FIGS. 4 A and 4 B are sketches showing the SPECIAL EXPANDABLE BOOSTER BENCHES on the seat of the vehicle.

FIG. 5 is an End View section of the Slide wall and T-section side assembly for the SPECIAL EXPANDABLE BOOSTER BENCHES.

FIGS. 6 A through 6 D are sketches of an alternative bench on the EXPANDABLE slide system with a back and side rails.

FIGS. 7 A through 7 E are sketches of an alternative bench on slide slots integral to the BOOSTER BENCHES.

FIGS. 8 A through 8 D are sketches of an alternative bench consisting of stackable BOOSTER BENCHES.

### DESCRIPTION OF THE DRAWINGS—REFERENCE NUMERALS

The following list refers to the drawings:

| Ref # | Description |
|---|---|
| 30 | Nested SPECIAL EXPANDABLE BOOSTER BENCHES |
| 30A | Lowermost or bottom BOOSTER BENCH - smallest |
| 30B | Middle BOOSTER BENCH - medium sized |
| 30C | Uppermost or top BOOSTER BENCH - largest |
| 31 | Expanded SPECIAL EXPANDABLE BOOSTER BENCHES |
| 32 | Padded means - cloth or equal - for comfort |
| 33 | Slide wall means to expand |
| 34 | Cup holder apertures |
| 35 | Means such as a Slot or equal to attach adjacent seat |
| 36 | Means to secure together benches that are not in use |
| 37 | Back of bench means to slide |
| 37A | Back of bench 30A means to slide |
| 37B | Back of bench 30B means to slide |
| 37C | Back of bench 30C means to slide |
| 38 | Lowermost slide wall 37A track section of bench 30A |
| 39 | Lowermost slide wall 37B “T” and track section of bench |
| | 30B |
| 40 | Lowermost slide wall 37C “T” section of bench 30C |
| 41 | Slide wall and T-section side assembly |
| 42 | Hinge means connecting slide walls to benches |
| 43 | Latch means |
| 43A | Aperture in bench 30 |
| 44 | Extended flexible attachment means |
| 45 | Squeezable device or the equivalent on attachment 44 |
| 46 | Apertures/voids between seats |
| 47 | Seat belt retaining and guide clips |
| 48 | Seat belt (not shown) |
| 49 | Back of vehicle seat |
| 50 | Bench portion of vehicle seat |
| 51 | Alternative top bench seat (30C) with a back |
| 52 | Alternative side arm rests |
| 53 | Removable side arm rests |
| 54 | Aperture to secure removable side arm rests 53 |
| L | Slide movement Directionally Left |
| R | Slide movement Directionally Right |
| 60 | Nested side slide alternative embodiment for EXPANDABLE |
| | BOOSTER BENCHES |
| 60A | Lowermost or Left sliding embodiment for EXPANDABLE |
| | BOOSTER BENCHES (bottom and smallest) |
| 60B | Middle or non-sliding embodiment for EXPANDABLE BOOSTER |
| | BENCHES (medium sized) |
| 60C | Uppermost or Right sliding embodiment for EXPANDABLE |
| | BOOSTER BENCHES (top and largest) |
| 61 | Expanded alternative embodiment for EXPANDABLE BOOSTER |
| 62 | Open aperture under sliding benches |
| 70 | Nested, individual alternative embodiment for |
| | EXPANDABLE BOOSTER BENCHES with no slide feature |
| 70A | Lowermost, individual alternative embodiment for |
| | EXPANDABLE BOOSTER BENCHES with no slide feature |
| | (bottom and smallest) |
| 70B | Middle, individual alternative embodiment for |
| | EXPANDABLE BOOSTER BENCHES with no slide feature |
| | (medium sized) |
| 70C | Uppermost, individual alternative embodiment for |
| | EXPANDABLE BOOSTER BENCHES with no slide feature |

### DETAILED DESCRIPTION OF PERFERRED EMBODIMENT

The present device is a Special Expandable Booster Bench 30 that has been developed for use by a person to mount and secure in a vehicle for use with multiple infants during transport. The device includes multiple benches 30 A, B and C that originally nest into one nested assembly 30, then may be expanded to a multiple bench system 31 with security features. The multiple benches may nest within each other. The device has a means to interlock with each other bench as well as means to lock the device to the vehicle seat.

The preferred embodiment of the device is comprised of a plurality of benches, a means to interlock or nest the benches, a means to connect to the vehicle seat, and other features for safety and convenience. This device relates to a Special Expandable Booster Bench and the like. Particularly this booster bench device is related to a booster seat system and combination that nests inside of one another until needed.

The improvement over the existing art is providing a bench device that:
a. is simple to use;
b. is compact;
c. is economical compared to multiple bench systems;
d. is easy to install; and
e. is durable and strong.

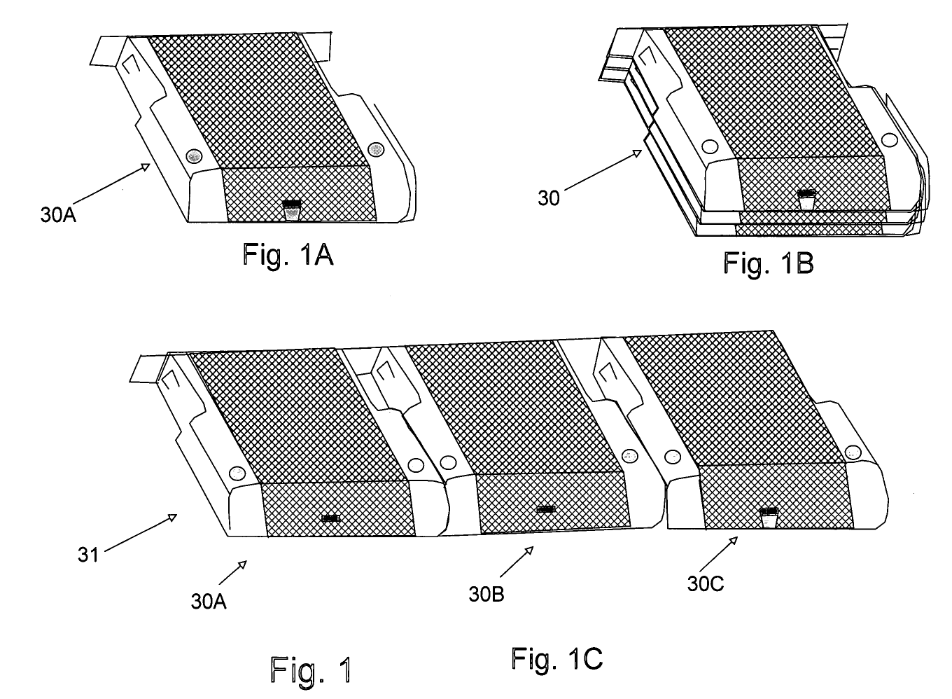

There is shown in FIGS. 1 through 8 a complete description of the operative embodiment of the Special Expandable Booster Bench 30. In the drawings and illustrations, one notes well that the FIGS. 1 through 8 demonstrate the general configuration and operation of this device. The preferred embodiment of the device is comprised of only a few parts as shown in the drawings. These members or parts include, but are not limited to, a plurality of benches 30 A, B, and C, a means to interlock or nest the benches 33, a means to connect to the vehicle seat 48, and other features for safety and convenience.

The accompanying drawings, which are incorporated in and constitute a part of this specification, illustrate an embodiment of the Special Expandable Booster Bench 30 that is preferred. The drawings together with the summary description given above and a detailed description given below serve to explain the principles of the Special Expandable Booster Bench 30. It is understood, however, that the Special Expandable Booster Bench 30 is not limited to only the precise arrangements and instrumentalities shown.

FIGS. 1 A through 1 C are sketches of a preferred embodiment of a SPECIAL EXPANDABLE BOOSTER BENCHES system. FIG. 1 A is the Lowermost or bottom BOOSTER BENCH 30A. FIG. 1 B is the Nested three SPECIAL EXPANDABLE BOOSTER BENCHES 30. FIG. 1 C is the Expanded SPECIAL EXPANDABLE BOOSTER BENCHES 31.

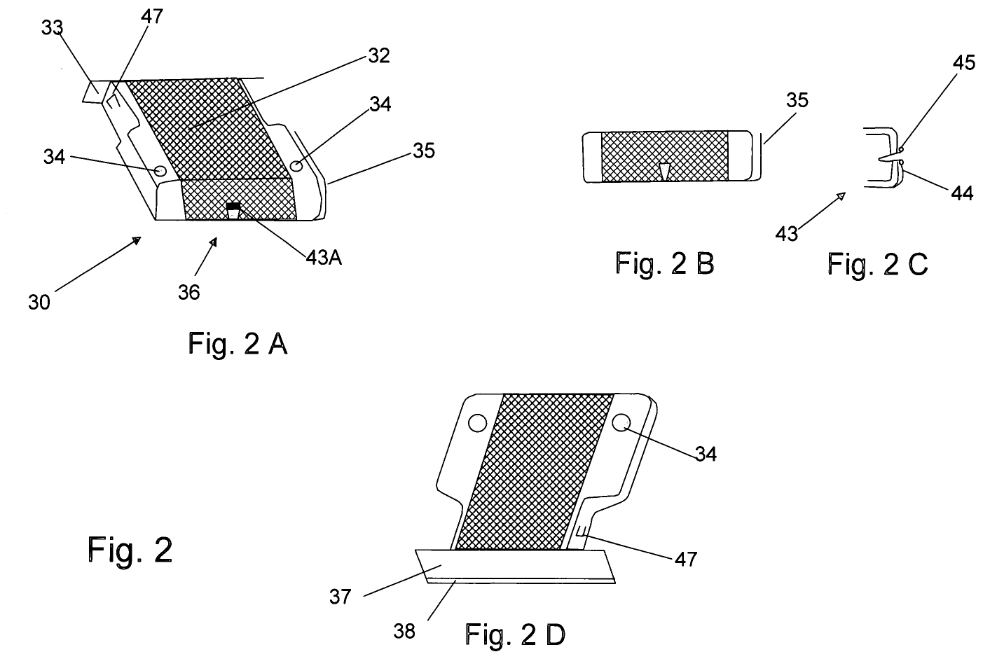

FIG. 2 A through 2 D are sketches of the Expanded SPECIAL EXPANDABLE BOOSTER BENCH 30 with the various components noted. When nested inside of each other three (3) booster bench become one (1) seat to use or store. The frame of the bench is constructed from a composite material such as a hard plastic, compressed fiber board, metal or the like. These materials are similar to those used in single boosters and most other car seats. The third bench 30C [one notes the 3^{rd} and top bench may be slightly larger in size than bench two (2) 30B in order to nest properly. For example as an illustration and not as a limitation, Bench unit 30A may have dimensions: 14″ wide at back, 20″ wide at the front, 16″ deep, 4″ tall at front and fade to 3½″ tall at the back. The 2^{nd} bench 30B may have dimensions: 14½″ wide at back, 20½″ wide at the front, 17″ deep, 4½″ tall at front and fade to 4″ tall at the back. The 3^{rd} bench 30C may have dimensions: 15″ wide at back, 21″ wide at the front, 18″ deep, 5″ tall at front and fade to 4½″ tall at the back.

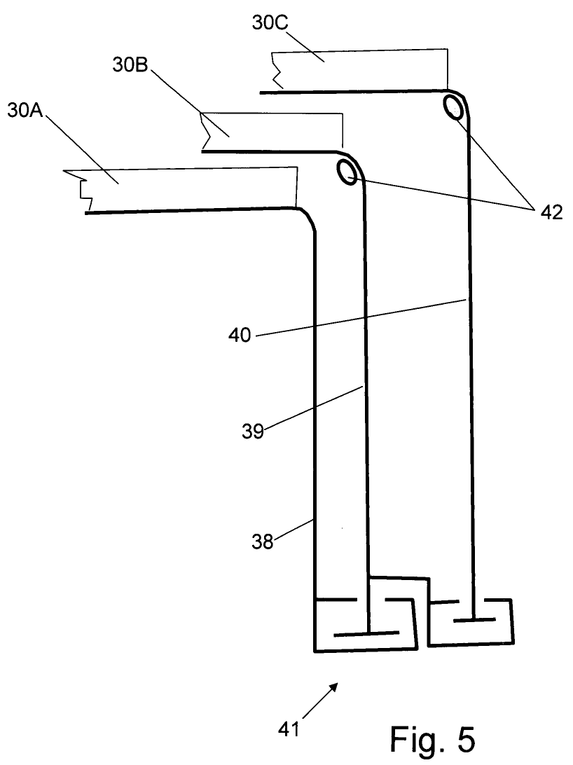

There is an optional padded cloth covering 32 for comfort. A slide wall 37 with features is explained below. There are optional cup holder apertures 34. A cut out or slot means 35 allows the benches to interlock. There is a latch means 43 to secure benches in conjunction with each other. When nested inside of each other 3 booster benches 30 A, B, and C become one (1) assembly 30 to use or store. This latch means 43 includes an aperture 43A in the benches, a squeezable latch means 45, and an extended attachment means 44 to secure the latch to the benches. This latch 45 squeezes together to release and pull out allowing the benches to pull apart for sliding. If only a two seat bench is needed, one slides the latch 45 back through the third bench 30C into the second bench 30B to secure the remaining two seats nested together. The flexible attachment 44 is secured from the latch 45 to the bottom seam of the material covering of the bench. This will allow the latch 45 to stay attached if dropped. Also shown is the slide wall 37 described below in FIG. 5. The slot 35 beside the cup holder 34 is to enable one to slide the side of the extended seat into to attach the fronts of the seats together.

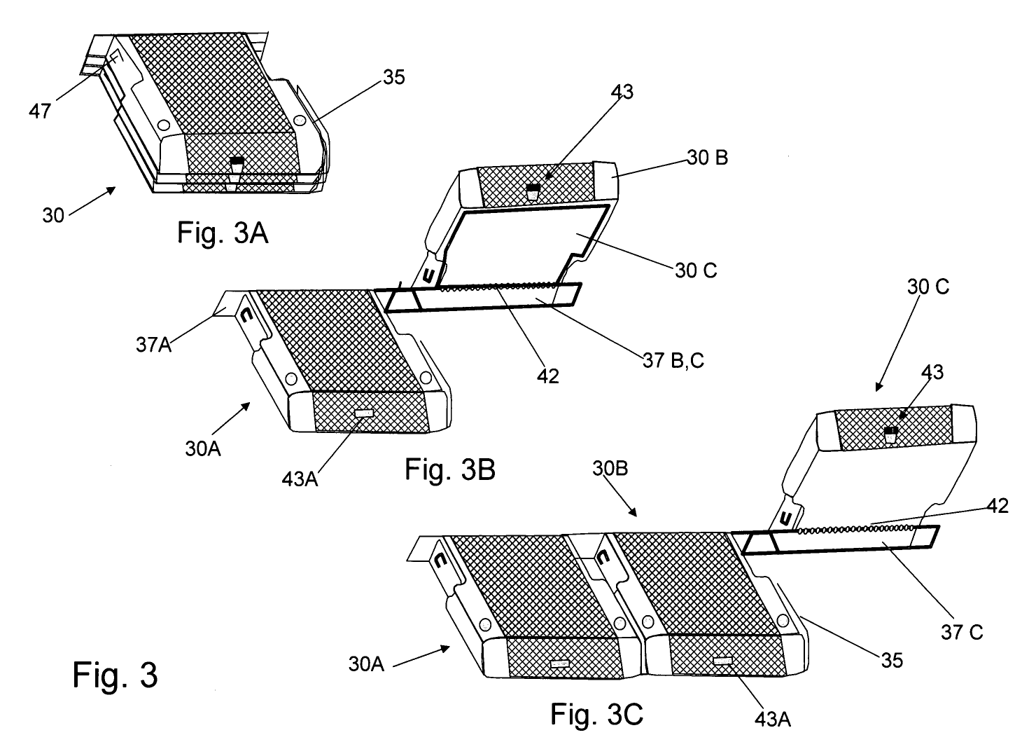

FIG. 3 A through 3 C are sketches showing the method of using the SPECIAL EXPANDABLE BOOSTER BENCHES 30. This is described below in the operation.

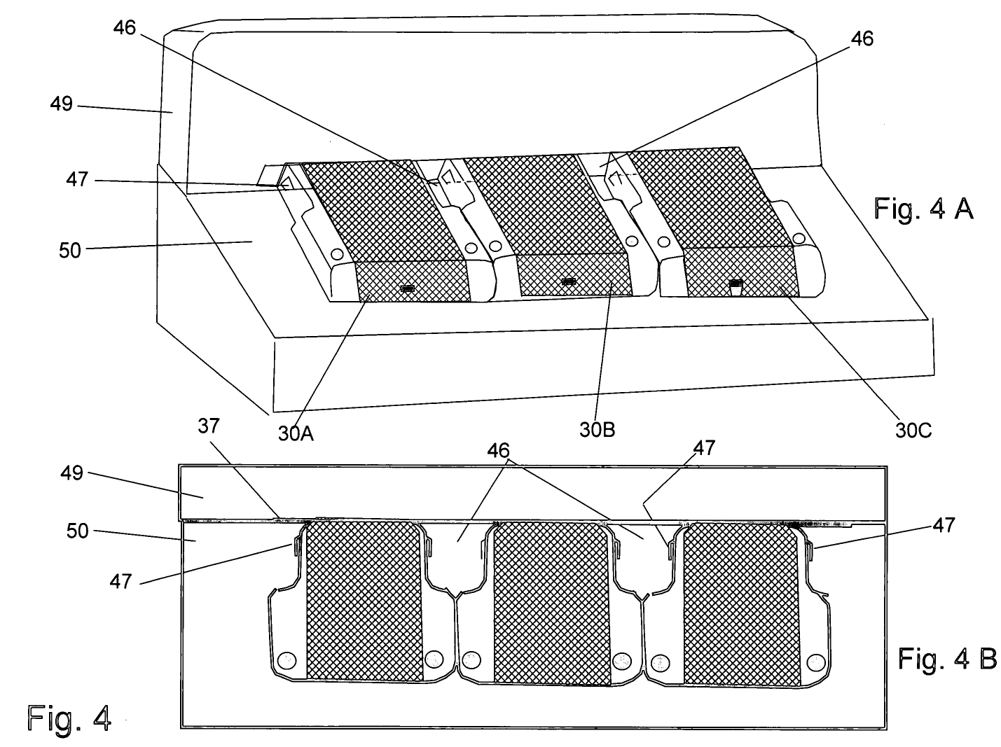

FIGS. 4 A and 4 B are sketches showing the SPECIAL EXPANDABLE BOOSTER BENCHES 30 on the seat 49, 50 of the vehicle. The units are on the seat 50 of the vehicle and attached securely by the seat belts 48 (not shown but well appreciated by one skilled in the art of vehicle safety devices) and secured in a position contiguous to the back 49 of the seat. The seat belts 48 are secured though the attachment means 47 that is integral or secured to the individual benches. The belts 48 run through the open spaces 46 between the benches 30 A, B, and C.

FIG. 5 is an End View section 41 of the Slide wall 37 and T and Track section side assembly for the SPECIAL EXPANDABLE BOOSTER BENCHES 30. The slide wall 37 made from materials similar to the benches of from thin metal. The lowermost section 39, 40 of slide walls on benches 30B and 30C will have an upside down “Tees” which will slide in the tracks on the back. The lowermost section of slide wall 38 in the back of bench one 30A is a track for bench two (2) 30B slide wall 39 to slide out to extend into a second bench 30B. There is a solid end piece at the end of the second T to prevent over sliding. The slide wall 39 in the back of the second bench also has a track for the “tee” on the lowermost slide wall 40 of bench three 30C to slide out to extend into a third bench 30C. There is a solid piece at the end of the third T to also prevent over sliding. Hinges 42 are on each of the top of slide walls 39, 40 of benches two 30B and three 30C to allow the front of each nested bench to be lifted to slide each individual bench to extend into the bench assembly 31.

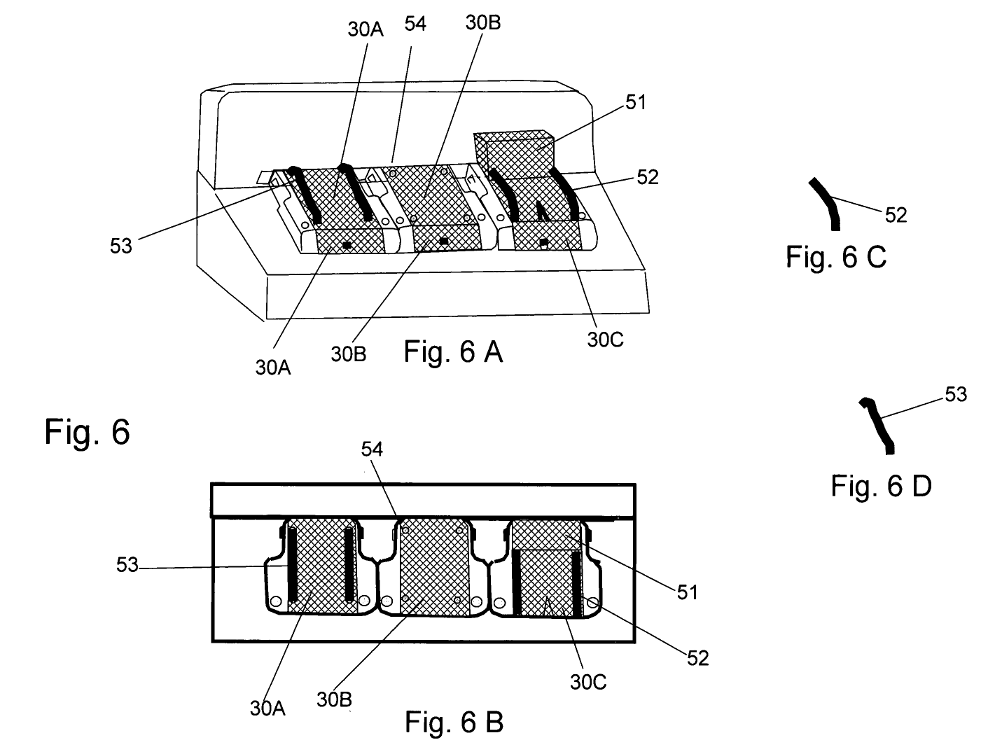

FIGS. 6 A through 6 D are sketches of an alternative bench on the EXPANDABLE slide system with a back 51 and side rails 52, 53. In this alternative embodiment, shown isometrically in FIG. 6 A provides the top bench 30C that has a back 51 featured as well as side rails 52. As shown in FIG. 6 A and the Top View FIG. 6 B, the lower nested benches 30B and 30A have apertures 54 to accept and secure removable side rails 53. FIGS. 6 C and 6 D show the arm rests or side rails 52, 53. One skilled in the art of rails and side arm rests or the like well appreciates the many configurations to accomplish this removable feature. This plethora of side rest configurations are within the scope and spirit of the alternative embodiment.

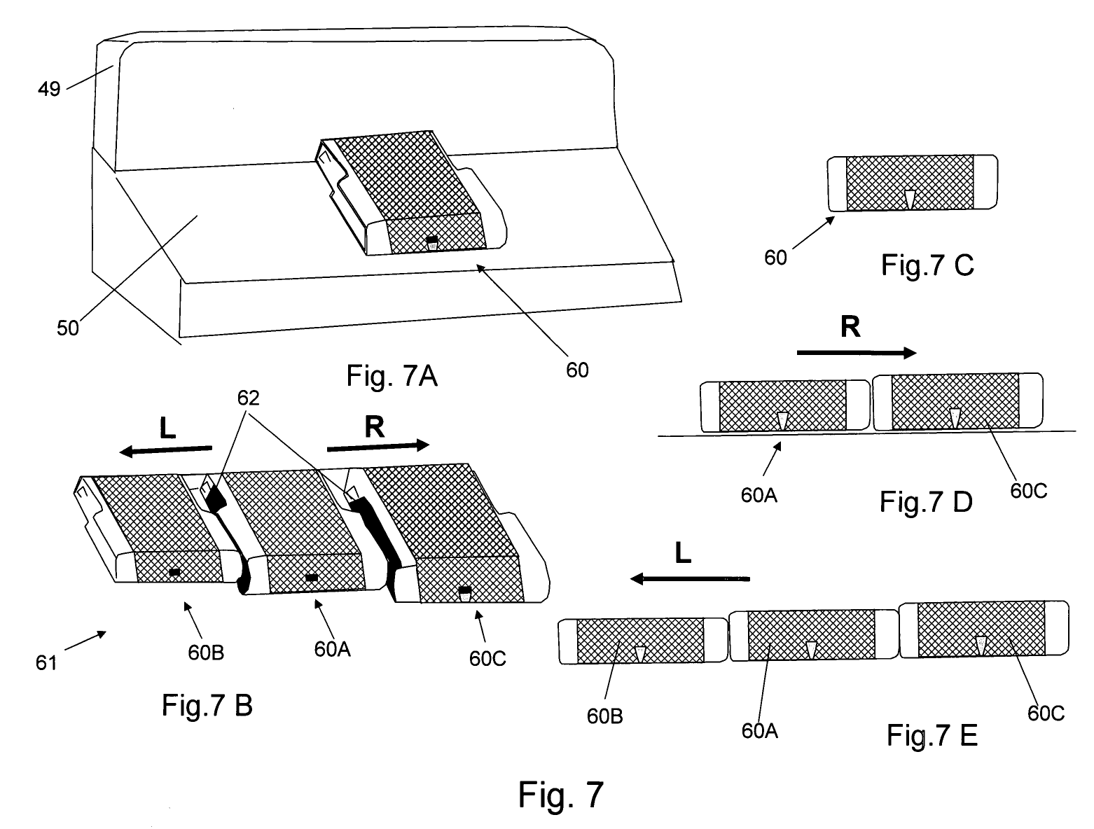

FIGS. 7 A through 7 E are sketches of an alternative bench system 60 with slide slots 62 integral to the BOOSTER BENCHES 60. Here top bench 60C and middle bench 60A have apertures 62 to permit the contiguous bench to nest within the next. The top bench 60 C is the largest bench. The middle bench 60A is similar yet smaller than the top bench 60C. Finally, the smallest bench 60B is smaller than the middle bench 60A. The left bench and smallest 60B slide Left L from the interior of the middle bench 60A and is exposed for use. In a similar manner, the top bench 60C slide to the Right R and the Middle bench 60A is then exposed for use. Alternative, removable side rails and backs may be incorporated if desired similar as discussed above in FIG. 6.

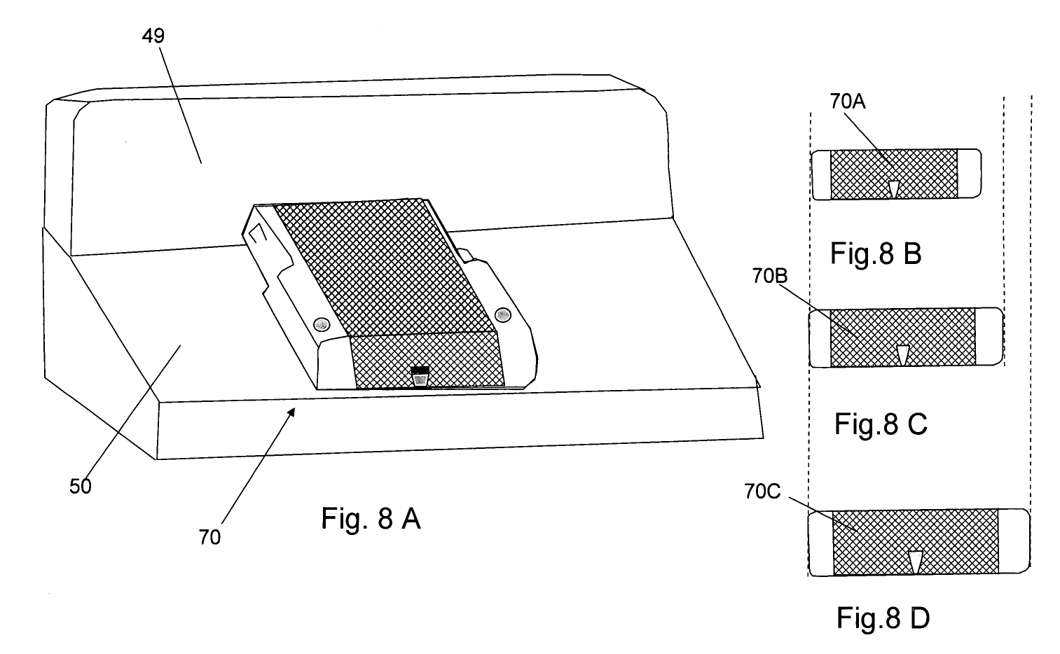

FIGS. 8 A through 8 D are sketches of an alternative bench consisting of stackable BOOSTER BENCHES 70. In this alternative configuration, the benches are all stackable and nest within the next. No slides or special openings or apertures are used. This simple configuration anticipates three or more separate benches. The smallest bench 70A is the lowermost bench. The medium sixe bench 70B is a little larger. The largest configured bench 70C is the largest or top bench. When one or more are not desired, the other(s) may nest and provide room or space for other uses. All the materials used for this and the other alternative embodiments anticipate similar materials to those discussed for the preferred embodiment.

The details mentioned here are exemplary and not limiting. Other specific components specific to describing a SPECIAL EXPANDABLE BOOSTER BENCHES 30 may be added as a person, having ordinary skill in the field of booster bench devices and related systems, well appreciates.

### OPERATION OF THE PREFERRED EMBODIMENT

The new SPECIAL EXPANDABLE BOOSTER BENCHES 30 has been described in the above embodiment. The manner of how the device operates is described below. One notes well that the description above and the operation described here must be taken together to fully illustrate the concept of SPECIAL EXPANDABLE BOOSTER BENCHES 30. In all cases either the preferred or one of the alternative embodiments are placed onto the vehicle seats. Then as the benches are put into place, the vehicle seat belts 48 are placed under the seat belt retaining and guide clips 47. Next, the child is placed on the bench. After that, the seat belt is placed around the child to secure the child in place on the bench. The method of adjusting the expandable booster bench system to multiple benches is described below. The steps shown are reversed in order to remove the child and to compact and nest the system back to a one bench configuration.

FIG. 3 A through 3 C are sketches showing the method of using the SPECIAL EXPANDABLE BOOSTER BENCHES 30. This is described below in the operation. FIG. 3 A is the nested benches 30. FIG. 3 B shows that when a second bench 30B is needed, one squeezes together and pulls out the latch 45 on the front of bench one 30A to release base unit 30A. Then one lifts the 2^{nd} & 3^{rd} benches 30B and 30C from the front up vertically into the air. The hinge means 42 on the underside at the back of the unit will pivot yet securely hold the benches to the slide wall 37. One slides the benches along the slide wall 37 until fully extended. Then one lowers the bench combination 30 B and C by the front sliding the left side into the slot 35 allowed beside the cup holder 34. FIG. 3 C shows that when a third seat is needed, one again squeezes together and pull out the latch 45 on the front of bench three 30C to release the 3^{rd} seat (top bench) from the 2^{nd} bench 30B (middle seat). One lifts the 3^{rd} bench 30C from the front up into the air. The hinge 42 on the underside at the back of the unit will hold into place. Again one slide along the slide wall 32 until the unit is fully extended. Then one lowers the bench 30C by the front sliding the left side into the slot 35.

The operation of the Alternative embodiments were described above in the descriptions.

With these descriptions it is to be understood that the SPECIAL EXPANDABLE BOOSTER BENCHES 30 is not to be limited to the disclosed embodiment. The features of the SPECIAL EXPANDABLE BOOSTER BENCHES 30 are intended to cover various modifications and equivalent arrangements included within the spirit and scope of the description.

What is claimed as new and desired to be protected by Letters Patent is:

1. An expandable booster bench system with multiple benches for use by a person with a vehicle, the system configured to allow the person to store the extra benches when not in use; the expandable booster bench system made with a durable material and comprising:
(a) a plurality of benches;
(b) a means to interlock the benches;
(c) a means to nest the benches;
(d) at least one seat in the vehicle;
(e) a means to connect the expandable booster bench system to the vehicle seat; and
(f) features for convenience
whereby the expandable booster bench system device is removably installable into the vehicle such that the system is secured to the vehicle.

2. The device according to claim 1 wherein the durable material is a composite material.

3. The device according to claim 2 wherein the composite material is plastic.

4. The device according to claim 2 wherein the composite material is a durable compressed fiber board.

5. The device according to claim 1 wherein the material is a metal.

6. The device according to claim 5 wherein the metal is steel.

7. The device according to claim 5 wherein the metal is aluminum.

8. The device according to claim 1 wherein the means to nest is a slidable wall comprised of “tees” and tracks whereby the slidable wall permits the benches to be lifted and pulled into place for use then retracted for nesting.

9. The device according to claim 1 wherein the means to nest is apertures along one side of two of the benches whereby the aperture permit the benches to be slid out and pulled into place for use then pushed back to the original place for nesting.

10. The device according to claim 1 wherein the feature for convenience are apertures to hold cups.

11. The device according to claim 1 wherein the features for convenience are padded bench covers.

12. An expandable booster bench system with multiple benches for use by a person with a vehicle, the system configured to allow the person to store the extra benches when not in use; the expandable booster bench system made with a durable material and comprising:
(a) a plurality of benches;
(b) a means to nest the benches;
(c) at least one seat in the vehicle;
(d) a means to connect the expandable booster bench system to the vehicle seat; and
(e) features for convenience
whereby the expandable booster bench system device is removably installable into the vehicle such that the system is secured to the vehicle.

13. The device according to claim 12 wherein the durable material is a composite material.

14. The device according to claim 13 wherein the composite material is plastic.

15. The device according to claim 13 wherein the composite material is a durable compressed fiber board.

16. The device according to claim 12 wherein the material is a metal.

17. The device according to claim 16 wherein the metal is steel.

18. The device according to claim 16 wherein the metal is aluminum.

19. The device according to claim 12 wherein the feature for convenience are apertures to hold cups.

20. The device according to claim 12 wherein the features for convenience are padded bench covers.
